(19) United States
(12) Patent Application Publication
(10) Pub. No.: US 2010/0064585 A1
(43) Pub. Date: Mar. 18, 2010

(54) Storm & security devices for doors

(76) Inventor: Robert Gertz, Vero Beach, FL (US)

Correspondence Address: Robert Gertz, 7320 45th St., Vero Beach, FL, 32967, US

(21) Appl. No.: 12/583,573

(22) Filed: Aug. 24, 2009

Related U.S. Application Data
(60) Provisional application No. 61/191,986, filed on Sep. 15, 2008.

(51) Int. Cl. E05C 19/18; E06B 7/00

(52) U.S. Cl. 49/70; 292/259 R

(57) ABSTRACT

Storm & security devices for doors including a bracket member removably mounted on either a top or side portion of a door jamb and then to an adjacent top or side portion of the door to thereby securely and releasably hold the door in a closed position. The bracket member can be formed as one L-shaped member, or as having two portions, one portion removably mounted to either a top or side portion of the door, and a second portion adapted to releasably interlock with the first portion and be removably mounted to a top or side portion of the door jamb to thereby removably hold the door in a closed position. An elongated bracket member can also be incorporated that is removably secured to opposite side portions of a door jamb thereby blocking the door from opening.

### PRIORITY

Priority is claimed to Provisional Application No. 61/191,986 filed on Sep. 15, 2008.

### FIELD OF INVENTION

This invention relates to doors and the reinforcement thereof to prevent such from opening due to forced entry or extreme weather related forces.

### BACKGROUND OF THE INVENTION

A need exists in hurricane prone areas for a simple but effective device to secure both single and double doors from blowing open during a storm. Standard door locks provide only a single point of support, and I have learned from my own experience that even moderate hurricane force winds (i.e., Hurricane Wilma, October, 2005, Vero Beach, Fla.) can dislodge a door, even if a deadbolt is engaged. This can happen by way of a jamb or astragal failure at the lock, disengagement of the lock under pressure, or in the case of double doors the top astragal bolt may slip down due to the ongoing movement of the wind.

Hurricane winds apply both a positive and negative forces on a door, so it could blow in or out. The failure of the door to remain fastened shut during a storm comprises a failure of the building envelope and allows the hurricane winds and water to enter the building, completely changing the wind pressure dynamics on the structure, often with serious consequences. Additionally, adding a secondary support to a door will greatly reduce warping forces on the door which may damage it even if it remains closed during a storm. There is a rising trend of the popularity of the 8′ tall doors. In the case of an 8′ tall door the distance from the door lock to the top of the door is much greater and increases the need for this type of product. These devices have additional applications as security devices in general, and would also be useful in the case of tornado and possibly flood water forces on an inswinging door.

The manufacture of these devices would be relatively simple and I do not believe costs would preclude viability.

### SUMMARY OF THE INVENTION

The instant invention relates to storm & security devices for doors and includes a bracket member removably mounted on either a top or side portion of a door jamb and then to an adjacent top or side portion of the door to thereby securely and releasably hold the door in a closed position. The bracket member can be formed as one L-shaped member, or as having two portions, one portion removably mounted to either a top or side portion of the door, and a second portion adapted to releasably interlock with the first portion and be removably mounted to a top or side portion of the door jamb to thereby removably hold the door in a closed position. An elongated bracket member can also be incorporated that is removably secured to opposite side portions of a door jamb thereby blocking the door from opening.

The designs set forth can be adapted for use with outswinging or inswinging doors. They can be mounted on the top jamb or on the side jamb. By mounting on the side jamb they can be placed at any height, and one could be placed near the bottom of the door as well. The designs gain strength by applying forces to the fasteners in shear and by going completely through the door.

One characteristic of the design is that they are not overly noticeable on the door, especially in the unsecured state. The product could be offered in white or bronze, or other finishes if desired.

### BRIEF DESCRIPTION OF THE DRAWINGS

FIG. 1 shows an angle bracket removably connected to a top portion of the door jamb and an adjacent portion of the door, and an elongated bracket removably connected to opposite sides of the door jamb, such that the door is removably secured in a closed position

FIG. 2 shows another embodiment of the angle bracket which is formed as two removably interlocked portions, the first removably connected to a top portion of the door jamb and the second interlocked with the first and then to an adjacent portion of the door.

FIG. 3a illustrates an exploded view of the bracket member formed in an L-shape.

FIG. 3b illustrates the bracket member of FIG. 3a installed upon a door and door jamb.

FIG. 4 illustrates an exploded view of another embodiment of the bracket incorporating two portions. The first portion formed having an extending tongue with a curved end, and the second having an elongated slot.

FIG. 5 illustrates an exploded view of another embodiment of the bracket incorporating two portions. A first portion formed as an L-shape and the second formed with bends.

FIG. 6a illustrates an exploded view of another embodiment of the two portion bracket. A first portion formed as an L-shape and having a bent distal end, and the second portion formed with bends and an elongated slot.

FIG. 6b illustrates the bracket member of FIG. 6a installed upon a door and door jamb.

FIG. 7 illustrates a bracket used for outswinging doors.

FIG. 8 illustrates an L-shaped bracket used in conjunction with the bracket of FIG. 7 for outswinging doors.

FIG. 9 illustrates a bracket used for inswinging doors.

FIG. 10 illustrates a bent bracket used in conjunction with the bracket of FIG. 9 for inswinging doors.

FIG. 11 illustrates a middle bracket used upon double doors.

FIGS. 12 and 13 illustrate brackets used on respective right and left frame portions of a double-door configuration.

FIG. 14 illustrates hardware parts used to releasably attach panel members to a door.

FIG. 15 illustrates another embodiment of the brackets used for inswinging doors.

### DESCRIPTION OF THE PREFERRED EMBODIMENT

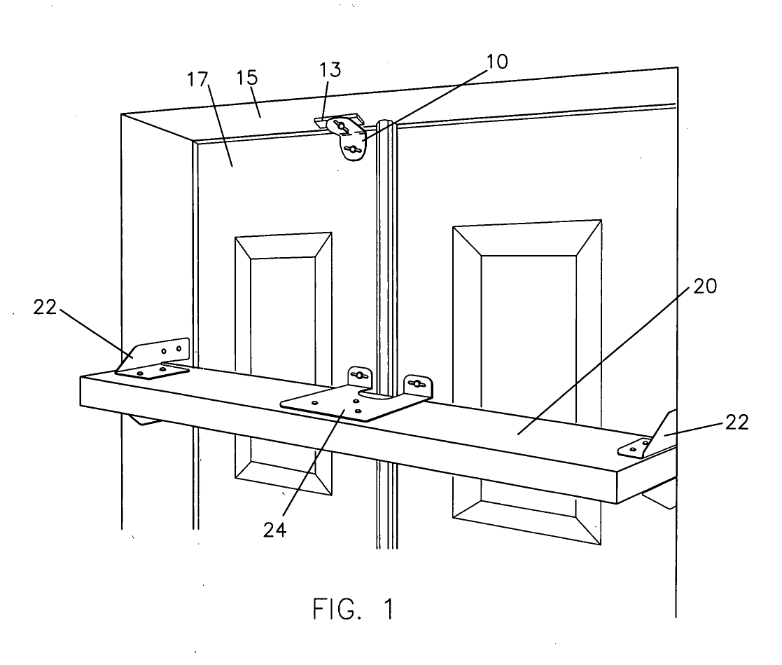

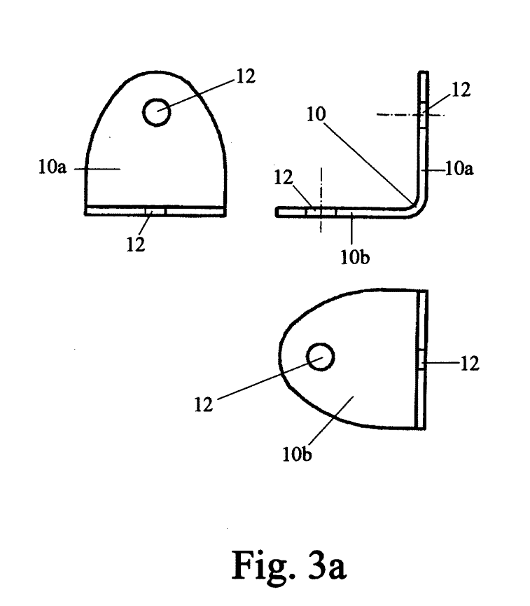

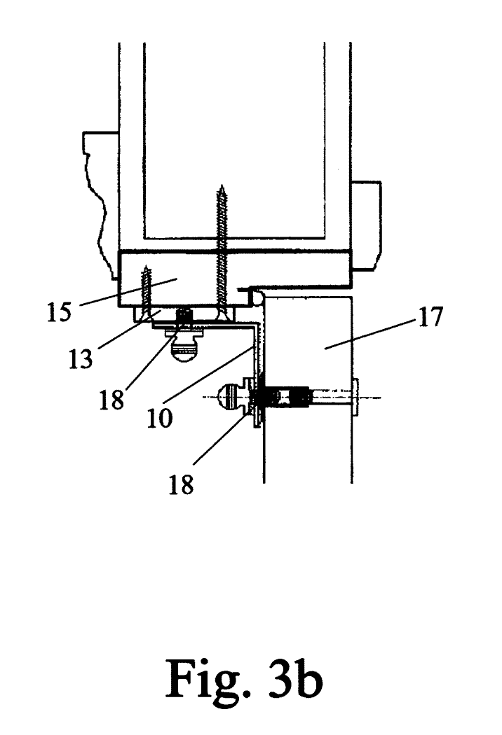

The preferred embodiment of the instant invention, best shown in the FIG. 1, shows a removable bracket 10 mounted on either the top or side portion of the door jamb 15 and then to an adjacent portion of a door 17. A support member 13 can also be implemented to more securely connect bracket 10 to door jamb 15 FIGS. 3a and 3b shows this bracket in the shape of an angle or L-shape having holes 12 for removable fasteners 18. The installation of this device requires the drilling of the holes, one of which is through the door and the other is through the door jamb. A first time installation should take no longer than 10 minutes. Then securing the door will take only a moment when the need arises.

FIG. 1 also shows an elongated bracket member 20 which can also be incorporated that is removably attached to opposite side portions of the door jamb via connector members 22 thereby blocking a door from opening. This bracket can also be secured at a center portion to the door itself via a center connector member 24. This elongated bracket member is very effective in double-door configurations wherein both doors are blocked and secured in the closed position at the same time.

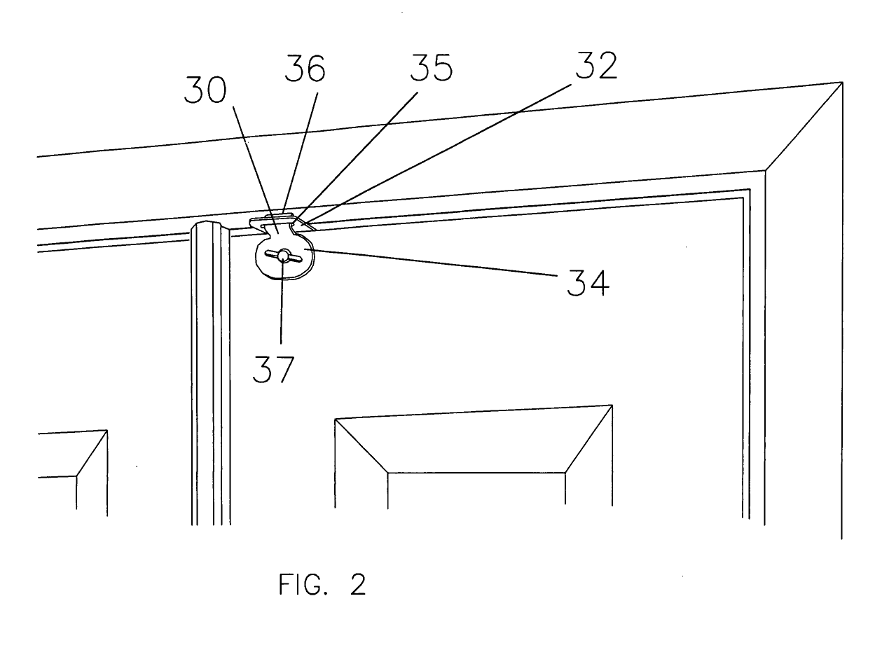

As shown in FIG. 2, the bracket member can be formed as bracket member 30 having two portions, one portion 32 removably mounted to either a top or side portion of the door jamb and having an opening 35, and a second portion 34 having an extended portion 36 adapted to releasably interlock with the opening of the first portion and then removably mounted to a top or side portion of the door to via a removable fastener 37, to thereby removably hold the door in a closed position.

As illustrated in FIGS. 3a & 3b, the bracket member can be formed in an L-shape, wherein opposite portions, 10a and 10b, include respective holes 12 for releasable fasteners 18 to pass therethrough and releasably hold the bracket to the door and door jamb respectively, thereby holding the door in a closed position.

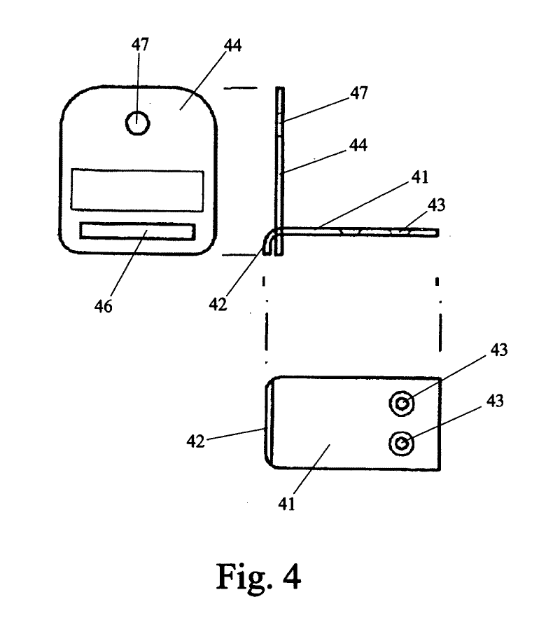

As illustrated in FIG. 4, another embodiment of the bracket incorporates two portions. The first portion 41 is formed having a curved end 42, and the second portion 44 having an elongated slot 46 therein. The second portion 44 includes a hole 47 for a removable fastener such that it can be releasably attached to a door jamb, and the first portion having holes 43 on one end for removable fasteners such that it can be releasably attached to a door, such that the curved end of the first portion can be placed within the elongated slot of the second portion, and then releasably attached to the door, thereby holding the door in a closed position.

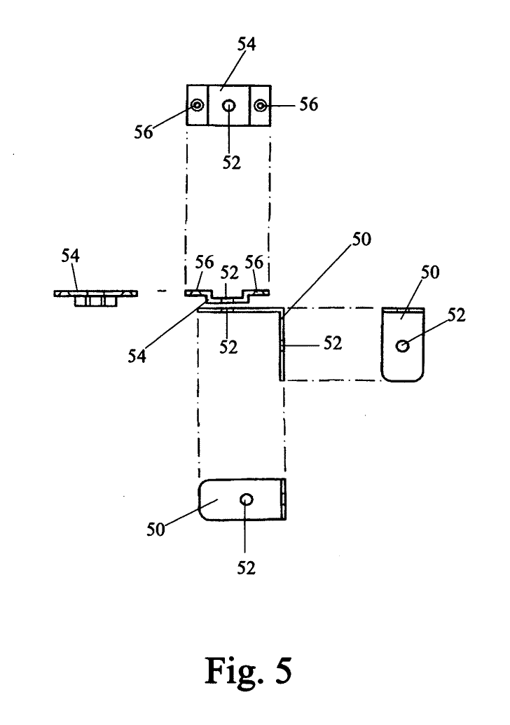

As illustrated in FIG. 5, another embodiment of the bracket incorporates two portions. A first portion 50 formed as an L-shape and the second portion 54 formed with bends. The second portion includes holes 56 for releasable fasteners such that it can be releasably attached to a door jamb, and the first portion 50 having holes 52 for releasable fasteners, such that the first portion can releasably connected to the bent portions of the second portion, and then releasably attached to both the door, thereby holding the door in a closed position.

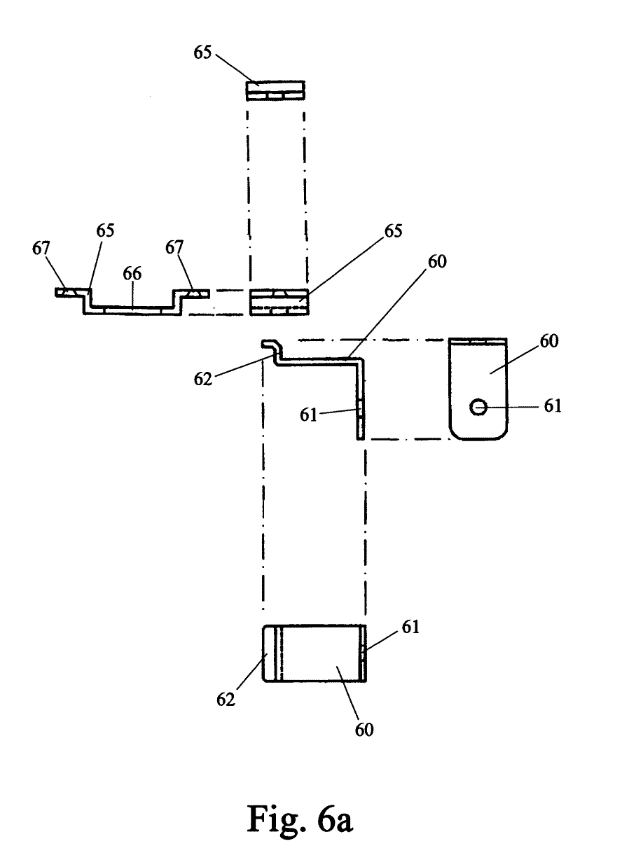

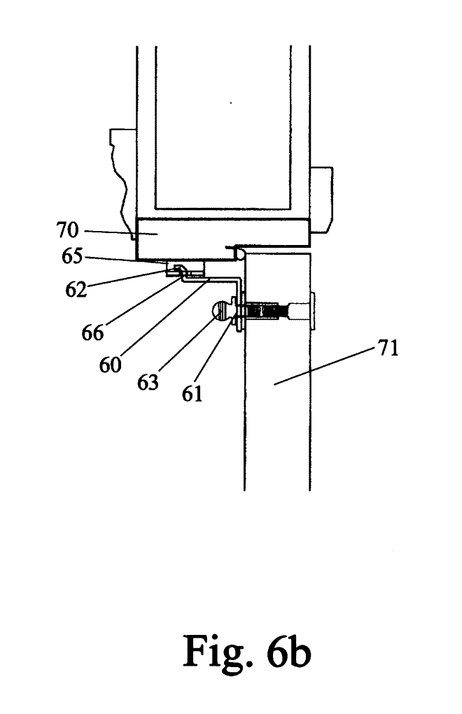

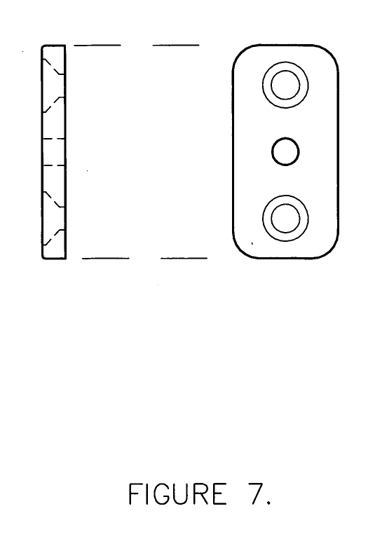

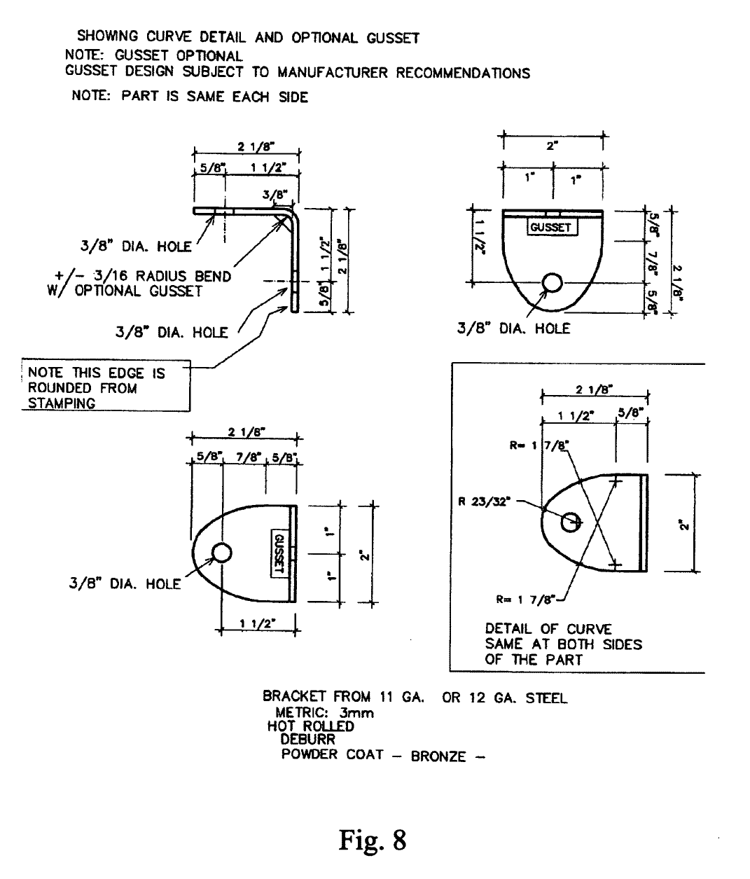

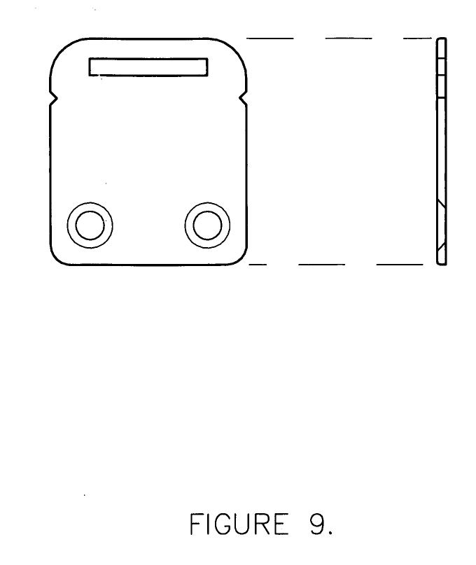

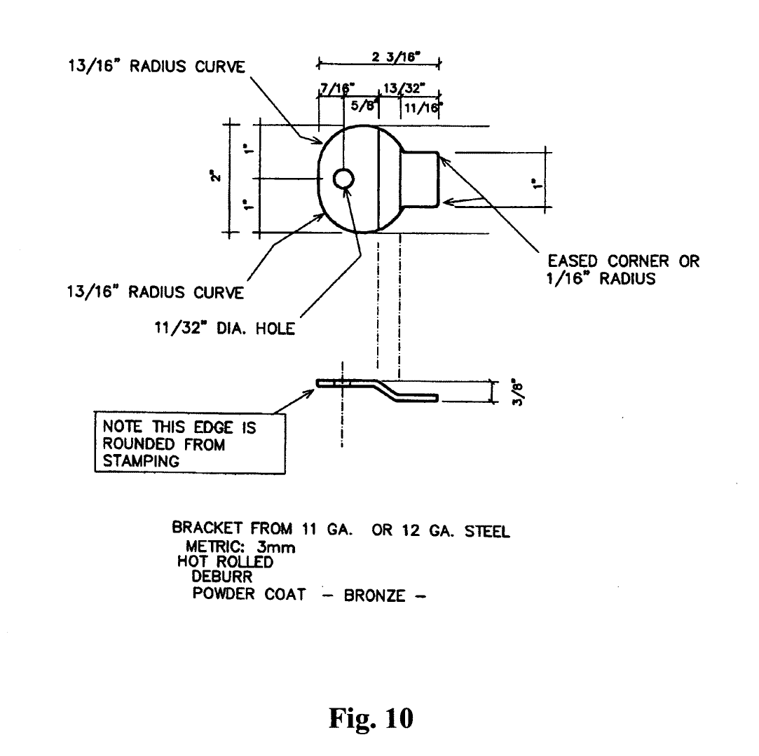

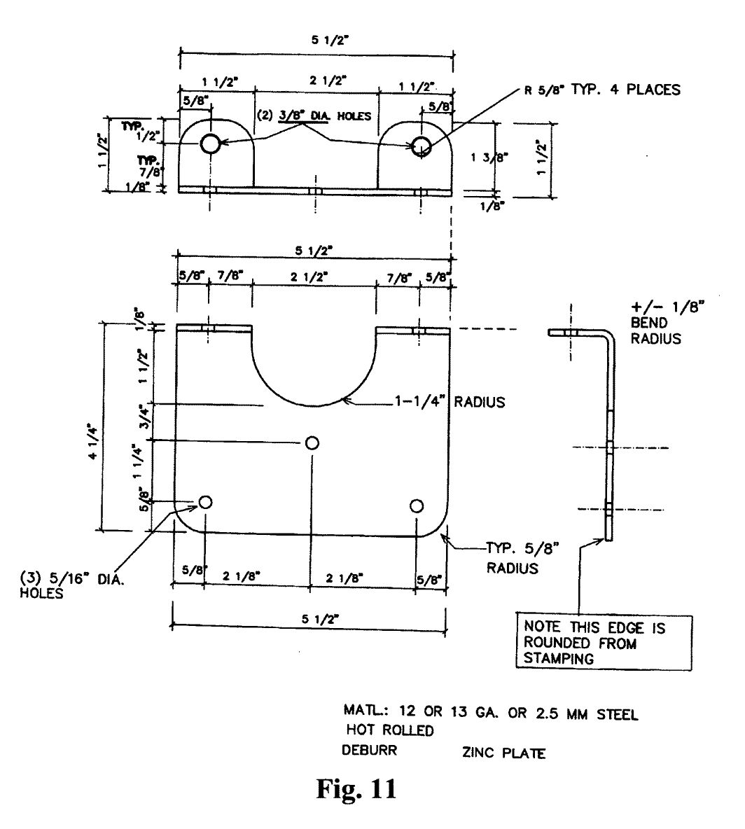

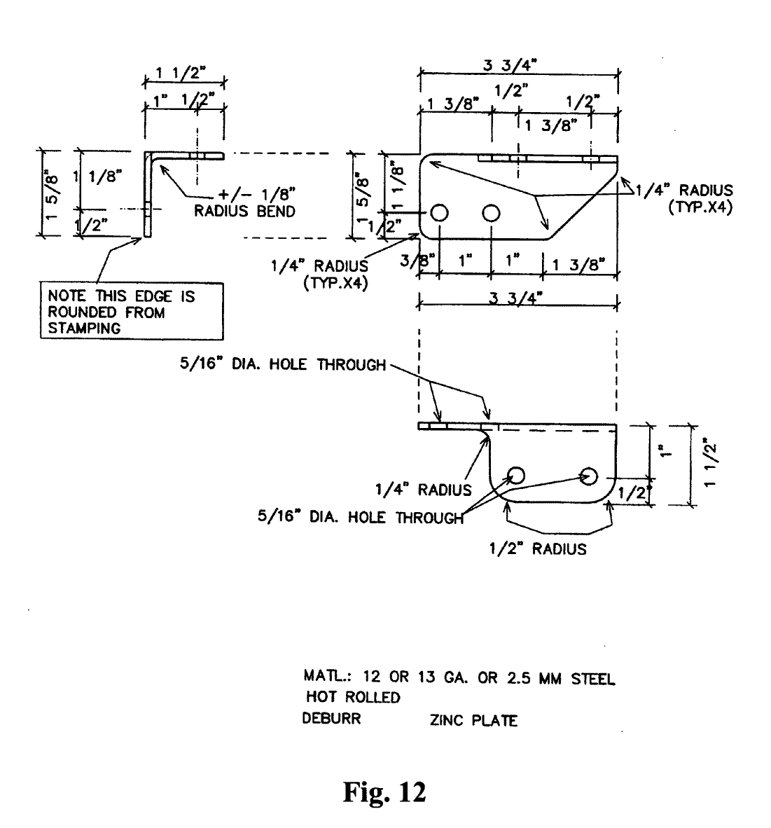

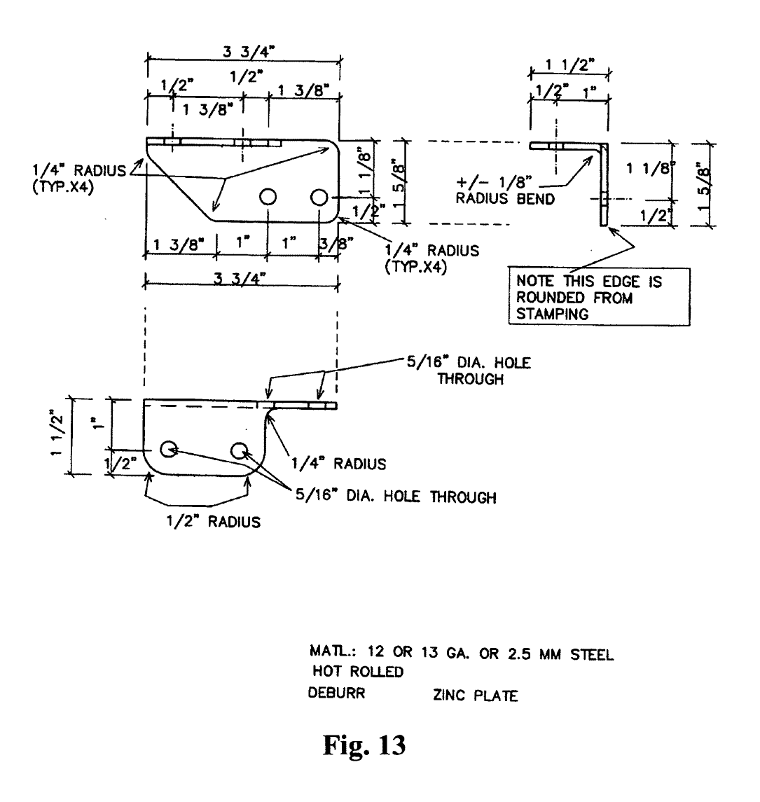

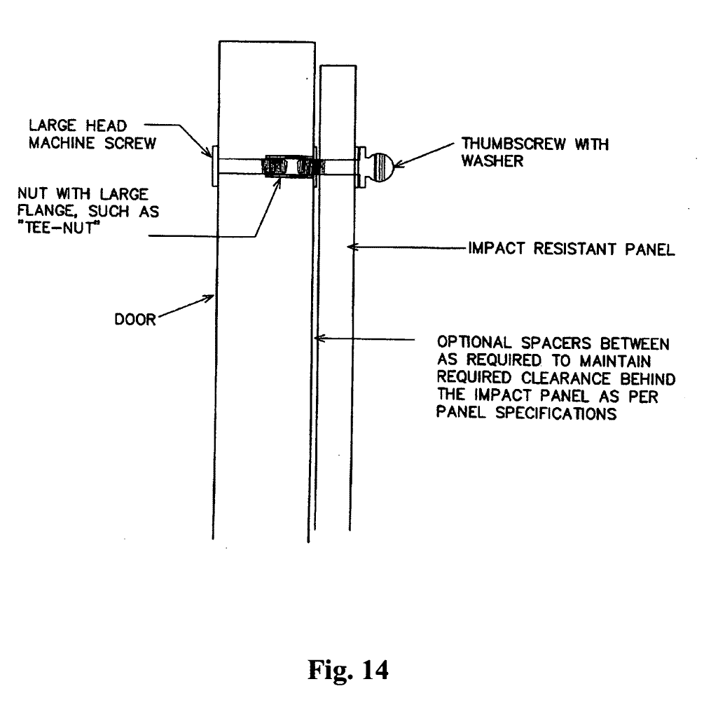

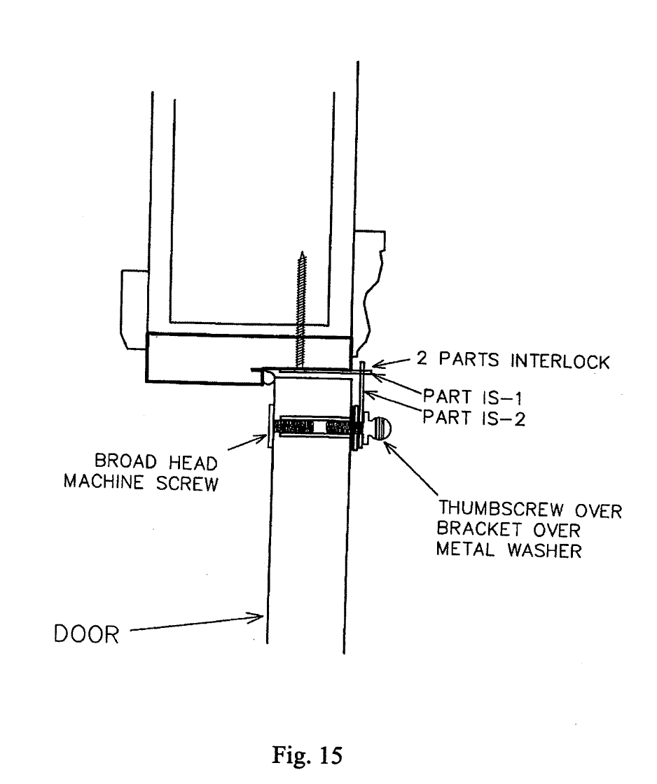

As illustrated in FIGS. 6a & 6b, another embodiment of the bracket also incorporating two portions. A first portion 60 formed as an L-shape and having a bent distal end 62, and the second portion 65 formed with bends and an elongated slot 66. The second portion 65 includes holes 67 for fasteners such that it can be releasably attached to a door jamb 70, and the first portion having hole 61 on one end for a releasable fastener 63, such that the bent distal end 62 of the first portion can be placed within and interlock with the elongated slot 66 of the second portion, and then releasably attached to the door 71, to thereby hold the door in a closed position.

The designs set forth can be used with either outswinging or inswinging doors. They can be mounted on the top jamb or on the side jamb. By mounting on the side jamb they can be placed at any height, and one could be placed near the bottom of the door as well. The designs gain strength by applying forces to the fasteners in shear and by going completely through the door.

Any and all other obvious modifications to one or more of the parts of this invention are inherently incorporated herein.

What is claimed:

1. A storm and security device adapted for use upon doors pivotally attached to door jambs, said storm and security device comprising a bracket adapted to be removably mounted to a portion of a door and an adjacent portion of the respective door jamb, to thereby removably secure said door in a fixed position with respect to said door jamb.

2. The storm and security device of claim 1, wherein said bracket is formed as an angle bracket having holes adapted to receive removable fasteners.

3. The storm and security device of claim 1, wherein said bracket is formed having two portions; a first portion is adapted to be releasably mounted to a door jamb and includes a hole, a removable fastener, and a gripping portion; a second portion is adapted to be releasably mounted to an adjacent portion of a respective door, and includes a hole, a removable fastener, and a gripping portion that is adapted to releasably interlock with said gripping portion of said first portion, such that when the two portions are interlocked and mounted to said door jamb and said door the door is removably secured in a closed position.

4. The storm and security device of claim 1, wherein said storm & security device comprises two brackets each adapted to be removably attached to separate portions of said door jamb; and a cross member formed to releasably contact both said two brackets at the same time, such that said door is held in a closed position by said cross member.

5. The storm and security device of claim 4, further comprising a center bracket adapted to releasably connect to an adjacent portion of said door; said center bracket further including a plate releasably connected to said cross member, to thereby more securely hold said door in a closed position.

6. The storm and security device of claim 1, wherein said bracket is adapted to have a material strength greater than the material strengths of commonly used doors and door jambs.

7. A combination of a door, a door jamb, and a storm & security device, said storm & security device comprising a bracket adapted to be removably mounted to a portion of said door and an adjacent portion of said door jamb, to thereby removably secure said door in a fixed position with respect to said door jamb.

8. The combination of claim 7, wherein said bracket is formed as an angle bracket having holes for removable fasteners; and wherein said door and said door jamb have holes that align with respective holes of said bracket, such that when said removable fasteners are placed and secured within each respective hole said door is removably secured in a closed position with respect to said door jamb.

9. The combination of claim 7, wherein said bracket is formed of two portions; a first portion is releasably mounted to said door jamb, and includes a hole, a removable fastener, and a gripping portion; a second portion is releasably mounted to said door in an area adjacent to said first portion, and includes a hole, a removable fastener, and a gripping portion that is adapted to releasably interlock with said gripping portion of said first portion, such that when the two portions are interlocked and mounted to the door jamb and door the door is removably secured in a closed position.

10. The combination of claim 7, wherein said bracket comprises two bracket members each removably attached to separate portions of said door jamb; and a cross member formed to releasably contact both said two bracket members at the same time, such that said door is held in a closed position by said cross member.

11. The combination of claim 10, wherein said door comprises two door members respectively movably connected to opposite sides of said door jamb, and wherein said cross member contacts a portion of each of said two door members, such that both of said two door members are secured in a closed position.

12. The combination of claim 10, further comprising a center bracket member adapted to releasably connect to adjacent portions of said two door members; said center bracket further including a plate releasably connected to said cross member, to thereby more securely hold said two door members in a closed position.

13. The combination of claim 7, wherein said storm & security device is designed to have a material strength greater than the material strengths of said door and said door jamb.
